(19) United States
(12) Patent Application Publication
(10) Pub. No.: US 2024/0316717 A1
(43) Pub. Date: Sep. 26, 2024

(54) INTELLIGENT MACHINE VISION SYSTEM FOR IN-PROCESS TOOL WEAR MONITORING

(71) Applicant: University of Kentucky Research Foundation, Lexington, KY (US)

(72) Inventor: Julius Malte Schoop, Lexington, KY (US)

(21) Appl. No.: 18/286,937

(22) PCT Filed: Apr. 14, 2022
(86) PCT No.: PCT/US22/24767

§ 371 Date: Oct. 13, 2023

Related U.S. Application Data
(60) Provisional application No. 63/175,717, filed on Apr. 16, 2021.

(51) Int. Cl. B23Q 17/24; B23Q 11/02

(52) U.S. Cl. CPC B23Q 17/249; B23Q 11/02

(57) ABSTRACT

An intelligent machine vision system for in-process monitoring of wear of a cutting tool includes a machine vision camera, a microscope, and a light source adapted for lighting the cutting tool to allow collection of cutting tool images with the machine vision camera. A CDC cutting machine for in-process monitoring of a cutting tool incorporates this machine camera vision system. Further, a method of in-process monitoring of a machine cutting tool includes the steps of displacing a spindle of the machine cutting tool to position the machine cutting tool held in the spindle for monitoring with a machine vision camera and collecting at least one image of a first cutting edge of the cutting tool.

### RELATED APPLICATION

This document claims priority to U.S. Provisional Patent Application Ser. No. 63/175,717 filed on Apr. 16, 2021, the full disclosure of which is hereby incorporated by reference.

### TECHNICAL FIELD

This document generally relates to tool wear monitoring systems and methods and, more particularly, to an intelligent machine vision system and related method for efficient and effective monitoring of a cutting tool while mounted in the spindle of a CNC cutting machine as well as to a CNC cutting machine incorporating that intelligent machine vision system.

### BACKGROUND

Most current tool methods for monitoring tool wear are operator-based and slow or inaccurate, relying on indirect measurement.

The intelligent machine vision system, method and CNC cutting machine disclosed herein all allow for rapid, direct optical measurement of tool wear by means of a machine vision camera, specialized optics and protection systems, as well as artificial intelligence ‘Deep Learning’ capabilities for automated tool-wear detection and measurement. The novel combination of a camera, microscope, LED illumination, and environmental protection system described in this document allow one to obtain high-resolution images of microscopic tool wear (between roughly 1-1000 microns of wear features). The system furthermore stores, analyzes and communicates these measurements with a machine tool controller and a secondary storage medium (cloud/local storage/Digital Thread) to allow for real-time adaptive control and changes to process parameters (feeds and speeds), as well as robust documentation of the state of wear of each tool used to produce a critical component (e.g., turbine blades and biomedical implants).

### SUMMARY

In accordance with the purposes and benefits described herein, a new and improved intelligent machine vision system is provided for in-process monitoring of wear of a cutting tool. That intelligent machine vision system comprises, consists essentially of or consists of: (a) a machine vision camera, (b) an environmentally protected microscope and (c) a light source adapted for lighting the cutting tool to allow collection of cutting tool images with the machine vision camera.

In one or more of the many possible embodiments of the intelligent machine vision system, the system further includes a shield housing including an internal compartment that receives and holds the microscope and an adapter connecting the machine vision camera to the shield housing. In some embodiments, the shield housing may take the form of a tube. In one or more of the many possible embodiments of the intelligent machine vision system, the system further includes an optical window closing a distal end of the shield housing and an ins overlying the optical window.

Still further, the intelligent machine vision system may include a base upon which the machine vision camera and the microscope are supported. That base may further include at least one vibration damper for supporting the base on a cutting machine such as a CNC cutting machine. A CNC cutting machine refers to a cutting machine with “computer numerical control” that is used to perform a subtractive manufacturing process that typically employs computerized controls and machine tools to remove layers of material from a blank or workpiece to produce a custom designed part.

In one or more of the many possible embodiments of the intelligent machine vision system, the system further includes a cutting tool cleaning device adapted for cleaning the cutting tool before the collection of cutting tool images with the machine vision camera.

The intelligent machine vision system also preferably includes a machine vision system controller adapted to control operation of the machine vision camera and the light source. The machine vision system controller preferably includes an input/output device adapted to communicate with a controller of the CNC cutting machine holding the cutting tool whereby the machine vision system controller directs the CNC controller to position the cutting tool for the collection of cutting tool images with the machine vision camera. Further, the machine vision system controller may be further adapted to receive the feedback from the machine vision camera and direct the CNC controller to position each cutting edge of the cutting tool for detailed imaging with the machine vision camera. Still further, the controller may be adapted to direct the CNC controller to position the cutting tool for cleaning by the cutting tool cleaning device before the collecting of cutting tool images with the machine vision camera.

In at least one particularly useful embodiment of the intelligent machine vision system, the light source is a ring light extending around the viewing field of the machine vision camera. In at least one particularly useful embodiment of the intelligent machine vision system, the cutting tool cleaning device includes an air cleaning system, a brush cleaning system or an air and brush cleaning system.

The machine vision camera may have a pixel size between about 2.0 to about 6.0 microns and a monochrome or color sensor featuring between about 0.5-25 megapixels. The microscope is a long working distance microscope. The long working distance microscope may have an objective magnification of at least 2× and a numerical aperture of at least 0.05. For certain applications, objective magnifications up to 20× and numerical aperture values of up to about 0.5 may be employed to resolve microscopic wear on very small cutting tools.

In accordance with an additional aspect, a new and improved CNC cutting machine is provided. That CNC cutting machine comprises; (a) a machine vision camera, (b) a microscope, and (c) a light source adapted for lighting the cutting tool to allow collection of cutting tool images with the machine vision camera.

In one or more of the many possible embodiments of the CNC cutting machine, the CNC cutting machine further includes a shield housing including an internal compartment that receives and holds the microscope and an adapter connecting the machine vision camera to the shield housing. In some embodiments, the shield housing may take the form of a tube. In one or more of the many possible embodiments of the CNC cutting machine, the CNC cutting machine further includes an optical window closing a distal end of the shield housing and an iris overlying the optical window. The purpose of the shield housing is to protect against ingress of cutting fluid and chips, which are commonly present in an industrial machine tool environment.

Still further, the CNC cutting machine may include a base upon which the machine vision camera and the microscope are supported. That base may further include at least one vibration damper for supporting the base on the machine vision system to isolate and protect it against vibrations that may occur within the CNC cutting machine during operation.

In one or more of the many possible embodiments of the CNC cutting machine, the CNC cutting machine further includes a cutting tool cleaning device adapted for cleaning the cutting tool before the collection of cutting tool images with the machine vision camera.

Still further, the CNC cutting machine includes a controller adapted to control operation of the machine vision camera and the light source. In addition, the controller may be adapted to receive feedback from the machine vision camera and position the cutting tool for the collection of cutting tool images with the machine vision camera. In addition, the controller may be adapted to receive the feedback from the machine vision camera and position each cutting edge of the cutting tool for detailed imaging with the machine vision camera. Further, in at least one possible embodiment, the controller is adapted to position the cutting tool for cleaning by the cutting tool cleaning device before the collecting of cutting tool images with the machine vision camera.

The light source may be a ring light extending around the viewing field of the machine vision camera. The cutting tool cleaning device may include an air cleaning system, a brush cleaning system or an air and brush cleaning system. The machine vision camera may have a pixel size between about 2.0 to about 6.0 microns and a monochrome or color sensor featuring between about 0.5 to about 25 megapixels. The microscope is a long working distance microscope. The long working distance microscope may have an objective magnification of at least 2× and a numerical aperture of at least 0.05. For certain applications, objective magnifications up to 20× and numerical aperture values of up to 0.5 may be employed to resolve microscopic wear on very small cutting tools

In accordance with yet another aspect, a new and improved method is provided for in-process monitoring of the condition of a cutting tool, including conditions such as wear, chipping, breakage, and radial runout/eccentricity. That method may be said to include the steps of displacing a spindle of a cutting tool machine to position the machine cutting tool held in the spindle for monitoring with a machine vision camera and collecting at least one image of a first cutting edge of the cutting tool.

In at least one of the many possible embodiments of the method, the method further includes the steps of repositioning the machine cutting tool held in the spindle and collecting at least one image of a second cutting edge of the cutting tool. For multi-flute cutting tools, indexing of the various flutes/edges may be achieved by means of indexing the machine tool spindle, which is a typical feature of many industrial CNC milling and turn-milling machine tools equipped with a motorized spindle and tool changer device. Still further, the method may include the steps of repositioning the machine cutting tool held in the spindle and collecting at least one image of another cutting edge of the cutting tool until all cutting edges of the cutting tool have been imaged. After the in-process tool wear monitoring is completed, those steps may then be followed by repositioning the cutting tool held in the spindle for machining of a workpiece.

Preferably, the method also includes the step of cleaning any workpiece chips and coolant from the cutting tool prior to collecting any of the images. That cleaning may be performed by (a) displacing the cutting tool held in the spindle into an air stream that blasts the workpiece chips and the coolant from the cutting tool, (b) displacing the cutting tool held in the spindle into a brush that whisks the workpiece chips and the coolant from the cutting tool or (c) displacing the cutting tool held in the spindle into a brush and an air stream to whisk and blast the workpiece chips and the coolant from the cutting tool.

In the following description, there are shown and described several preferred embodiments of the intelligent machine vision system, the CNC cutting machine incorporating the intelligent machine vision system and the related method of in-process monitoring of a machine cutting tool. As it should be realized, the intelligent machine vision system, the CNC cutting machine incorporating the intelligent machine vision system and the related method are capable of modification in various, obvious aspects all without departing from the intelligent machine vision system, the CNC cutting machine incorporating the intelligent machine vision system and the related method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the patent specification, illustrate several aspects of the intelligent machine vision system, the CNC cutting machine incorporating the intelligent machine vision system and the related method and together with the description serve to explain certain principles thereof.

FIG. 1 is a schematic representation of the new and improved intelligent machine vision system for in-process monitoring of the wear of a cutting tool.

FIG. 2 is a schematic block diagram illustrating the machine vision system controller and its operative connection to other components of the intelligent machine vision system and the controller of the CNC cutting machine for which in-process tool wear monitoring is being provided.

FIG. 3 is a perspective view illustrating the camera, adapter, shield housing, and light ring of the intelligent machine vision system with a cutting tool held in the spindle of a CNC cutting machine wherein the cutting tool is positioned for imaging.

FIG. 4 is a detailed perspective view of the light ring, and iris of the intelligent machine vision system.

FIG. 5 is a schematic view of a CNC cutting machine incorporating the intelligent machine vision system.

Reference will now be made in detail to the present preferred embodiments of the intelligent machine vision system, the CNC cutting machine incorporating the intelligent machine vision system and the related method examples of which are illustrated in the accompanying drawing figures.

### DETAILED DESCRIPTION

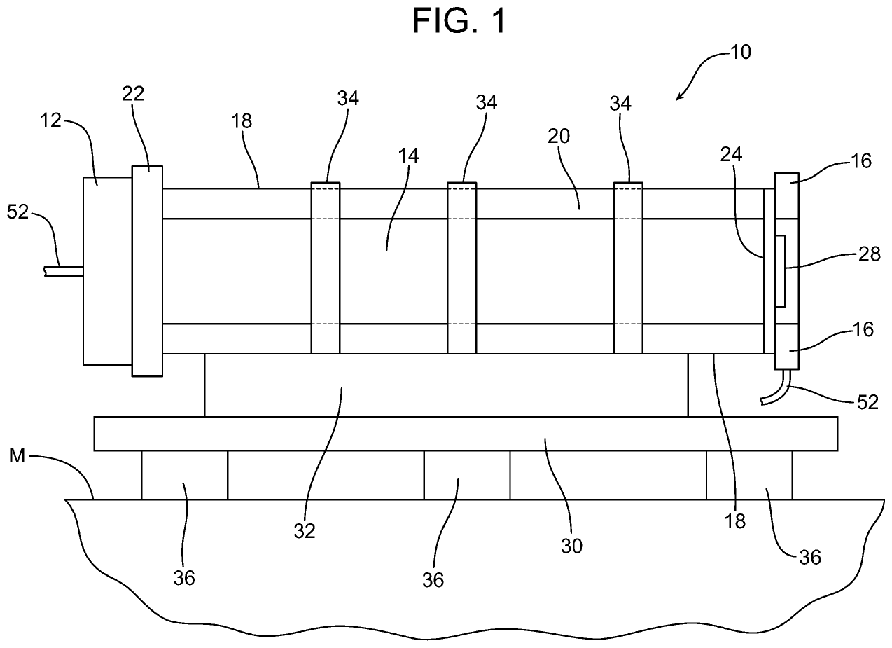

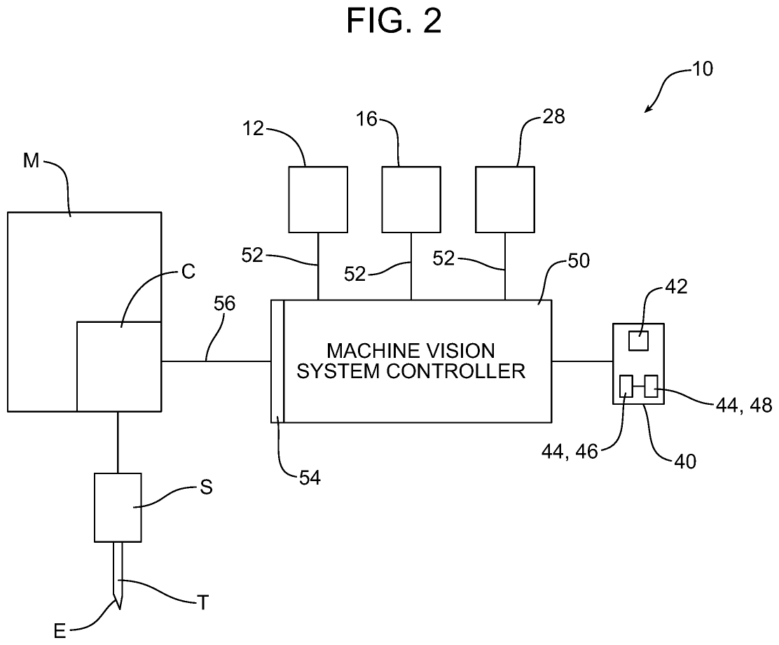

Reference is now made to FIGS. 1 and 2 which schematically illustrates one possible embodiment of the new and improved intelligent machine vision system 10 for in-process monitoring of wear of a cutting tool T. As illustrated, the vision system 10 includes a machine vision camera 12, a microscope 14, connected to the machine vision camera, and a light source 16.

The machine vision camera 12 may be of a type known in the art, such as a Vieworks VC-25MC camera, having a C-mount, a 4.5 micron or smaller pixel size and a 16.933 mm or larger monochrome sensor. The microscope 14 may be a long working distance microscope of a type known in the art, such as a Mitutoyo VMU microscope, with an objective magnification of 2X (e.g., Mitutoyo M Plan objective) or greater and a numerical aperture (NA) of 0.05 or greater. The light source 16 may be of a type known in the art, such as a Smart Vision Lights RM140IP67 LED darkfield ring light.

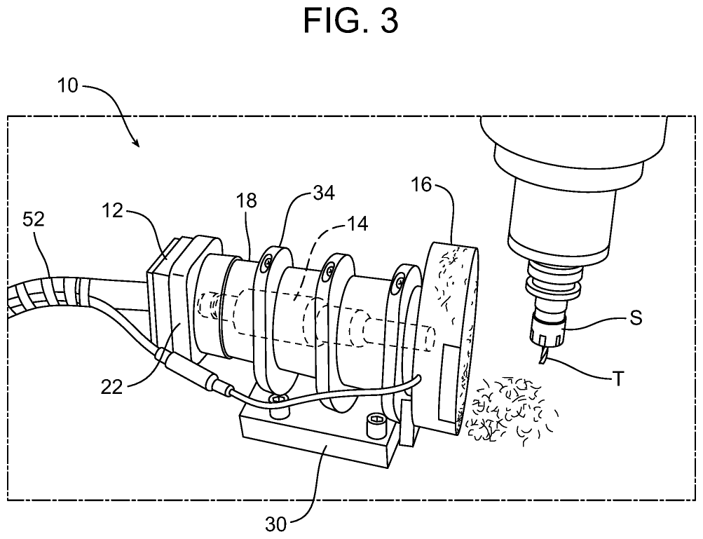

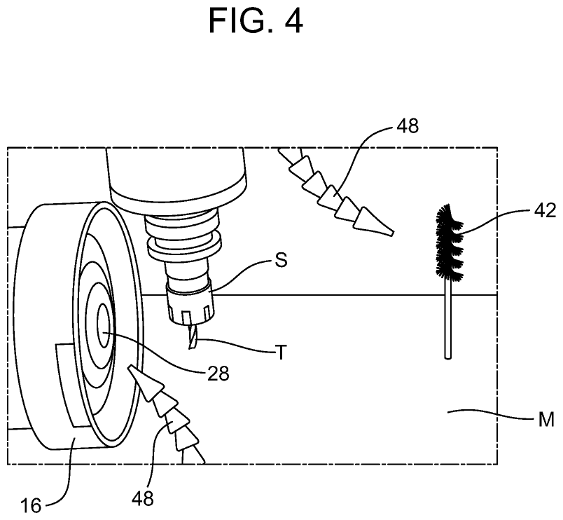

The intelligent machine vision system 10 further includes a shield housing 18 including an internal cavity 20 that receives and holds the microscope 14. See also FIGS. 3 and 4. The shield housing 18, which may take the form of a tube, is made from any appropriate material adapted to protect the microscope from coolant and chip ingress associated with the harsh environment of a cutting machine M. An adapter 22 connects the camera 12 to the proximal end of the shield housing 18. Associated gaskets (not shown) may be provided to ensure a watertight connection.

An optical window 24 made of optical glass, quartz or other appropriate material closes and seals the distal end of the shield housing 18. The optical window 24 may have a thickness of, for example, 6 mm or greater in order to provide some mechanical strength to resist cracking or breaking from any inadvertent impact as may occur in the harsh cutting machine environment. An optional coating with an oil and water-repellent coating may be applied to the optical window to reduce the need for cleaning of this window. Moreover, an optional anti-reflection (AR) coating may be applied to the optical window to reduce undesirable reflections and glare. An optional electronic iris 28, of a type known in the art, may be provided over the portion of the optical window 24 through which the camera 12 views the cutting tool T. When closed, the iris 28 protects the window 24 from being obscured in any way by coolant or workpiece chips associated with the harsh cutting tool environment. When opened, a clear line of sight is provided for the camera 12 to view the cutting tool T.

The intelligent machine vision system 10 may also include a base 30 having a cradle 32 and associated mounting straps 34 adapted to secure the shield housing 18 to the base. The base 30 may include at least one vibration damper 36 positioned between the base and the CNC cutting machine M so that the camera 12 and microscope 14 supported on the base are protected from vibration associated with the operation of the CNC cutting machine M.

The intelligent machine vision system 10 may also include a cutting tool cleaning device, generally designated by reference numeral 40. In the illustrated embodiment, the cutting tool cleaning device 40 includes both a brush cleaning system, represented by a stationary brush 42, and an air cleaning system 44, represented by the air source 46 and the associated air jet 48. In alternative embodiments of the intelligent machine vision system 10, the cleaning system 40 may comprise either the brush cleaning system 42 or the air cleaning system 44. The cleaning device 40 is adapted to clean the cutting tool T prior to collecting images with the camera 12 as will be described in greater detail below. Further, in some embodiments, the same air jet 48 (or another air jet) may be pointed toward the light source 16 and the iris 28 to provide an air stream blast to remove workpiece chips and coolant from the light source and the iris before opening the iris and collecting images of the cutting tool T.

The intelligent machine vision system 10 further includes a machine vision system controller 50 (see FIG. 2). A wiring harness 52 connects the machine vision system controller 50 to the camera 12, the light source 16 and, if present, the electronic iris 28. An input/output device 54 connected to or integrated into the controller 50, of a type known in the art, is adapted to allow the machine vision system controller 50 to communicate with the controller C of the CNC cutting machine M through the communication bus 56 or by wireless connection. The CNC cutting machine controller C is adapted for indexing/displacing the spindle S that holds the cutting tool T into any desired position within the range of spindle movement of the CNC cutting machine M.

The machine vision system controller 50 may be a programmable computing device, an electronic control unit (ECU) or a dedicated microprocessor, of a type known in the art, that is associated with appropriate software or hardware adapted to:
(a) communicate with and direct the CNC controller C to position and displace the cutting tool for cleaning by the cutting tool cleaning device 40 before the collecting of any cutting tool images;
(b) control operation of the machine vision camera 12, the light source 16 and, if present, the optional iris 28; and
(c) receive feedback from the machine vision camera, communicate with the controller C of the CNC cutting machine M and direct the CNC controller to position the cutting tool T for collection of cutting tool images with the machine vision camera.

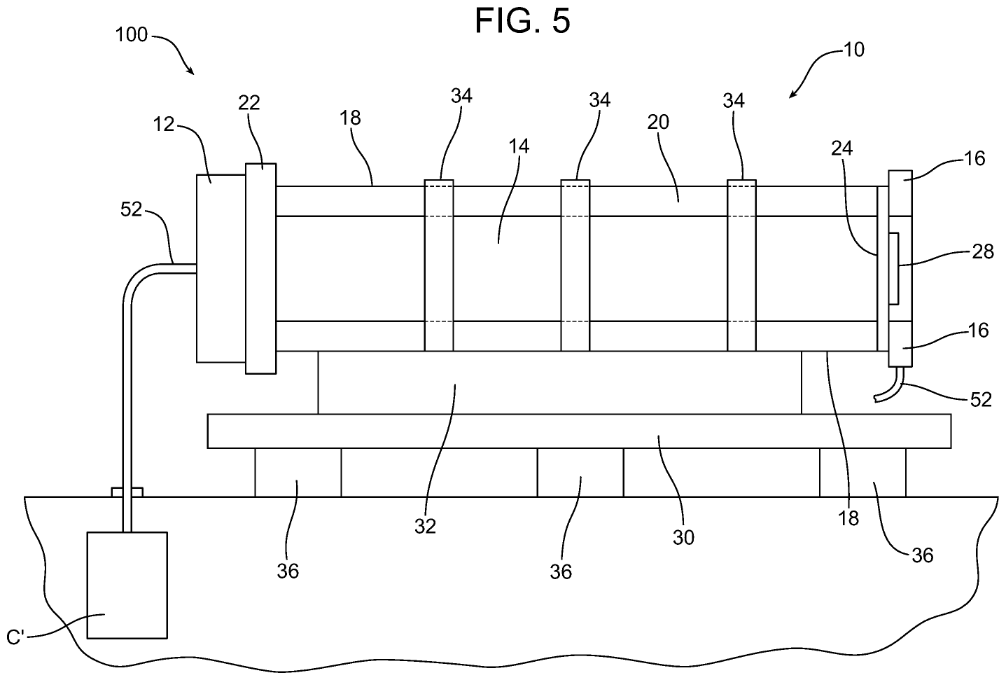

Reference is now made to FIG. 5 which schematically illustrates a CNC cutting machine 100 incorporating the intelligent machine vision system 10′ of the type generally described above. The intelligent machine vision system 10′ of the CNC machine 100 includes the machine vision camera 12, the microscope 14, the light source 16 and various other component parts of the intelligent machine vision system 10 previously described and the reference numbers for those shared component parts are used in FIG. 5. The only difference between the intelligent machine vision system 10 described above, in connection with FIG. 1-4, and the intelligent machine vision system 10′ of the CNC cutting machine 100 illustrated in FIG. 5 is the fact that the machine vison system controller 50 described above has been integrated into the CNC cutting machine controller C′.

As a result, the controller C′ of the CNC cutting machine 100 is adapted to;
(a) control indexing and movements of the spindle holding the cutting tool;
(b) control operation of the machine vision camera 12, the light source 16 and, if present, the optional iris 28; and
(c) receive feedback from the machine vision camera, and direct the positioning of the cutting tool T for cleaning with the cleaning device 40 and for the subsequent collection of cutting tool images with the machine vision camera.

The machine vision system controller 50 of the machine vision system 10 and the controller C′ of the CNC cutting machine 100 described above may be further adapted to store the cutting tool images taken with the camera 12 and even analyze those images with artificial intelligence to allow for real-time adaptive control and changes to process parameters (feeds and speeds), as well as robust documentation of the state of wear of each tool used to produce a critical component. Such an artificial intelligence algorithm may consider semantic segmentation of the captured images into categories, such as ‘tool’, ‘background’, ‘wear’, ‘chips’, ‘chipping’, and any number of other potentially relevant categories. Once the algorithm identifies the worn portion of the tool, measurement of the area (e.g., in square pixels or square millimeters for a calibrated camera system) or standardized dimensions (e.g., flank wear width per ISO 8688-2:1989(en)) may be carried out, using methods well-established in the art. Based on measurement of the wear progression, the algorithm may furthermore graph and potentially extrapolate the remaining useful life of a cutting tool. Moreover, automated wear measurement furthermore enables optimization of cutting parameters, once a range of parameters (feeds and speeds) have been evaluated by the system. Additionally, implementation of a model-based process controller, e.g., considering the relationship between tool-wear and quality of the workpiece or profitability of the cutting operation, may be carried out to adaptively change the process parameters of the CNC controller for any subsequent cuts with an increasingly worn tool. Such closed-loop application of the smart machine vision system within an adaptive machining paradigm is considered a potentially useful and novel application of automated vision-based cutting tool condition monitoring technology applied within a machine tool environment, without the need for operator intervention during measurement.

Either of the intelligent machine vision system 10 connected to the CNC machine M, described above and shown in FIGS. 1-4, or the CNC cutting machine 100, described above and shown in FIG. 5, are associated with a new and improved method for in-process monitoring of a machine cutting tool T. That method may be broadly said to include the steps of: (a) displacing a spindle S of the machine cutting machine M or 100 to position the machine cutting tool T held in the spindle for monitoring with a machine vision camera 12 and (b) collecting at least one image of a first cutting edge E of the cutting tool.

The method may further include the steps of: repositioning the machine cutting tool T held in the spindle S and collecting at least one image of a second cutting edge E of the cutting tool. Still further, the method may include the steps of repositioning the machine cutting tool T held in the spindle S and collecting at least one image of another cutting edge E of the cutting tool until all cutting edges of the cutting tool have been imaged. After the in-process tool wear monitoring is completed, those steps may then be followed by repositioning the cutting tool T held in the spindle for machining of a workpiece (not shown).

The method also includes the step of cleaning any workpiece chips and coolant from the cutting tool prior to collecting any of the images. That cleaning may be performed by (a) displacing the cutting tool T held in the spindle S into an air stream emanating from an air jet 46 that blasts the workpiece chips and the coolant from the cutting tool, (b) displacing the cutting tool held in the spindle into a brush 42 that whisks the workpiece chips and the coolant from the cutting tool or (c) displacing the cutting tool held in the spindle into a brush and an air stream to whisk and blast the workpiece chips and the coolant from the cutting tool.

This disclosure may be considered to relate to the following items:

1. An intelligent machine vision system for in-process monitoring of wear of a cutting tool, comprising:
a machine vision camera;
a microscope; and
a light source adapted for lighting the cutting tool to allow collection of cutting tool images with the machine vision camera.

2. The intelligent machine vision system of item 1, further including a shield housing including an internal compartment that receives and holds the microscope and an adapter connecting the machine vision camera to the shield housing.

3. The intelligent machine vision system of item 2, further including an optical window closing a distal end of the shield housing and an iris overlying the optical window.

4. The intelligent machine vision system of item 3, further including a base upon which the machine vision camera and the microscope are supported.

5. The intelligent machine vision system of item 4, further including at least one vibration damper supporting the base on a CNC cutting machine.

6. The intelligent machine vision system of item 5, further including a cutting tool cleaning device adapted for cleaning the cutting tool before the collection of cutting tool images with the machine vision camera.

7. The intelligent machine vision camera of any of items 1-6, further including a machine vision system controller adapted to control operation of the machine vision camera and the light source.

8. The intelligent machine vision system of item 7, wherein the machine vision system controller includes an input/output device adapted to communicate with a controller of the CNC cutting machine holding the cutting tool whereby the machine vision system controller directs the CNC controller to position the cutting tool for the collection of cutting tool images with the machine vision camera.

9. The intelligent machine vision system of item 8, wherein the machine vision system controller is further adapted to receive the feedback from the machine vision camera and direct the CNC controller to position each cutting edge of the cutting tool for detailed imaging with the machine vision camera.

10. The intelligent machine vision system of item 9, wherein the controller is further adapted to direct the CNC controller to position the cutting tool for cleaning by the cutting tool cleaning device before the collecting of cutting tool images with the machine vision camera.

11. The intelligent machine vision system of item 10, wherein the light source is a ring light extending around the viewing field of the machine vision camera.

12. The intelligent machine vision system of item 11, wherein the cutting tool cleaning device includes an air cleaning system, a brush cleaning system or an air and brush cleaning system.

13. The intelligent machine vision system of item 12, wherein the machine vision camera has a pixel size of between about 2.0 and 6.0 microns and a sensor featuring between about 0.5 and about 25 megapixels.

14. The intelligent machine vision system of item 13, wherein the microscope is a long working distance microscope.

15. The intelligent machine vision system of item 14, wherein the long working distance microscope has an objective magnification of at least 2× and a numerical aperture of at least 0.05.

16. The intelligent machine vision system of item 1, further including a base upon which the machine vision camera and the microscope are supported.

17. The intelligent machine vision system of item 1, further including a cutting tool cleaning device adapted for cleaning the cutting tool before the collection of cutting tool images with the machine vision camera.

18. A CNC cutting machine including a cutting tool, comprising:
a machine vision camera;
a microscope; and
a light source adapted for lighting the cutting tool to allow collection of cutting tool images with the machine vision camera.

19. The CNC cutting machine of item 18, further including a shield housing including an internal compartment that receives and holds the microscope and an adapter connecting the machine vision camera to the shield housing.

20. The CNC cutting machine of item 19, further including an optical window closing a distal end of the shield housing and an iris overlying the optical window.

21. The CNC cutting machine of item 20, further including a base upon which the machine vision camera and the microscope are supported.

22. The CNC cutting machine of item 21, further including at least one vibration damper supporting the base on a CNC cutting machine.

23. The CNC cutting machine of item 22, further including a cutting tool cleaning device adapted for cleaning the cutting tool before the collection of cutting tool images with the machine vision camera.

24. The CNC cutting machine of any of items 18-23, further including a controller adapted to control operation of the machine vision camera and the light source.

25. The CNC cutting machine of item 24, wherein the controller receives feedback from the machine vision camera and positions the cutting tool for the collection of cutting tool images with the machine vision camera.

26. The CNC cutting machine of item 25, wherein the controller is further adapted to receive the feedback from the machine vision camera and position each cutting edge of the cutting tool for detailed imaging with the machine vision camera.

27. The CNC cutting machine of item 26, wherein the controller is further adapted to position the cutting tool for cleaning by the cutting tool cleaning device before the collecting of cutting tool images with the machine vision camera.

28. The CNC cutting machine of item 27, wherein the light source is a ring light extending around the viewing field of the machine vision camera.

29. The CNC cutting machine of item 28, wherein the cutting tool cleaning device includes an air cleaning system, a brush cleaning system or an air and brush cleaning system.

30. The CNC cutting machine of item 29, wherein the machine vision camera has a pixel size of between about 2.0 and about 6.0 microns and a sensor featuring between about 0.5 and about 25 megapixels.

31. The CNC cutting machine of item 30, wherein the microscope is a long working distance microscope.

32. The CNC cutting machine of item 31, wherein the long working distance microscope has an objective magnification of at least 2× and a numerical aperture of at least 0.05.

33. The CNC cutting machine of item 18, further including a cutting tool cleaning device adapted for cleaning the cutting tool before the collection of cutting tool images with the machine vision camera.

34. A method of in-process monitoring of a machine cutting tool, comprising:

displacing a spindle to position the machine cutting tool held in the spindle for monitoring with a machine vision camera; and

collecting at least one image of a first cutting edge of the cutting tool.

35. The method of item 34, further including (a) repositioning the machine cutting tool held in the spindle and (b) collecting at least one image of a second cutting edge of the cutting tool.

36. The method of item 35, further including (a) repositioning the machine cutting tool held in the spindle and (b) collecting at least one image of another cutting edge of the cutting tool until all cutting edges of the cutting tool have been imaged.

37. The method of item 36, further including repositioning the cutting tool held in the spindle for machining of a workpiece.

38. The method of item 37, further including cleaning any workpiece chips and coolant from the cutting tool prior to collecting any of the images.

39. The method of item 38, wherein the cleaning is performed by displacing the cutting tool held in the spindle into an air stream that blasts the workpiece chips and the coolant from the cutting tool.

40. The method of item 39, wherein the cleaning is performed by displacing the cutting tool held in the spindle into a brush that whisks the workpiece chips and the coolant from the cutting tool.

41. The method of item 40, wherein the cleaning is performed by displacing the cutting tool held in the spindle into a brush and an air stream to whisk and blast the workpiece chips and the coolant from the cutting tool.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a light source”, as used herein, may also refer to, and encompass, a plurality of light sources.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the intelligent machine vision system 10, the CNC cutting machine 100 incorporating the intelligent machine vision system 10′ and the related method have been illustratively described and presented by way of specific exemplary embodiments, and examples thereof, it is evident that many alternatives, modifications, or/and variations, thereof, will be apparent to those skilled in the art. It is intended that all such alternatives, modifications, or/and variations, fall within the spirit of, and are encompassed by, the broad scope of the appended claims.

1. An intelligent machine vision system for in-process monitoring of wear of a cutting tool, comprising:
a machine vision camera;
a microscope;
a light source adapted for lighting the cutting tool to allow collection of cutting tool images with the machine vision camera; and
a shield housing including an internal compartment that receives and holds the microscope and an adapter connecting the machine vision camera to the shield housing.

2. (canceled)

3. The intelligent machine vision system of claim 1, further including an optical window closing a distal end of the shield housing and an iris overlying the optical window.

4. The intelligent machine vision system of claim 3, further including a base upon which the machine vision camera and the microscope are supported.

5. The intelligent machine vision system of claim 4, further including at least one vibration damper for supporting the base on a CNC cutting machine.

6. The intelligent machine vision system of claim 5, further including a cutting tool cleaning device adapted for cleaning the cutting tool before the collection of cutting tool images with the machine vision camera.

7. The intelligent machine vision camera of claim 1, further including a machine vision system controller adapted to control operation of the machine vision camera and the light source.

8. The intelligent machine vision system of claim 7, wherein the machine vision system controller includes an input/output device adapted to communicate with a controller of the CNC cutting machine holding the cutting tool whereby the machine vision system controller directs the CNC controller to position the cutting tool for the collection of cutting tool images with the machine vision camera.

9. The intelligent machine vision system of claim 8, wherein the machine vision system controller is further adapted to receive the feedback from the machine vision camera and direct the CNC controller to position each cutting edge of the cutting tool for detailed imaging with the machine vision camera.

10. The intelligent machine vision system of claim 9, wherein the controller is further adapted to direct the CNC controller to position the cutting tool for cleaning by the cutting tool cleaning device before the collecting of cutting tool images with the machine vision camera.

11. The intelligent machine vision system of claim 10, wherein the light source is a ring light extending around the viewing field of the machine vision camera.

12. The intelligent machine vision system of claim 11, wherein the cutting tool cleaning device includes an air cleaning system, a brush cleaning system or an air and brush cleaning system.

13. The intelligent machine vision system of claim 12, wherein the machine vision camera has a pixel size of between about 2.0 and about 6.0 microns and a sensor featuring between about 0.5 and about 25 megapixels.

14. The intelligent machine vision system of claim 13, wherein the microscope is a long working distance microscope.

15. The intelligent machine vision system of claim 14, wherein the long working distance microscope has an objective magnification of at least 2× and a numerical aperture of at least 0.05.

16. The intelligent machine vision system of claim 1, further including a base upon which the machine vision camera and the microscope are supported.

17. An intelligent machine vision system for in-process monitoring of wear of a cutting tool, comprising:
a machine vision camera;
a microscope: and;
a light source adapted for lighting the cutting tool to allow collection of cutting tool images with the machine vision camera; and
a cutting tool cleaning device adapted for cleaning the cutting tool before the collection of cutting tool images with the machine vision camera.

18. A CNC cutting machine including a cutting tool, comprising:
a machine vision camera;
a microscope;
a light source adapted for lighting the cutting tool to allow collection of cutting tool images with the machine vision camera; and
a shield housing including an internal compartment that receives and holds the microscope and an adapter connecting the machine vision camera to the shield housing.

19. (canceled)

20. The CNC cutting machine of claim 18, further including an optical window closing a distal end of the shield housing and an iris overlying the optical window.

21. The CNC cutting machine of claim 20, further including a base upon which the machine vision camera and the microscope are supported.

22. The CNC cutting machine of claim 21, further including at least one vibration damper for supporting the base on a CNC cutting machine.

23. The CNC cutting machine of claim 22, further including a cutting tool cleaning device adapted for cleaning the cutting tool before the collection of cutting tool images with the machine vision camera.

24. The CNC cutting machine of claim 18, further including a controller adapted to control operation of the machine vision camera and the light source.

25. The CNC cutting machine of claim 24, wherein the controller receives feedback from the machine vision camera and positions the cutting tool for the collection of cutting tool images with the machine vision camera.

26. The CNC cutting machine of claim 25, wherein the controller is further adapted to receive the feedback from the machine vision camera and position each cutting edge of the cutting tool for detailed imaging with the machine vision camera.

27. The CNC cutting machine of claim 26, wherein the controller is further adapted to position the cutting tool for cleaning by the cutting tool cleaning device before the collecting of cutting tool images with the machine vision camera.

28. The CNC cutting machine of claim 27, wherein the light source is a ring light extending around the viewing field of the machine vision camera.

29. The CNC cutting machine of claim 28, wherein the cutting tool cleaning device includes an air cleaning system, a brush cleaning system or an air and brush cleaning system.

30. The CNC cutting machine of claim 29, wherein the machine vision camera has a pixel size of between about 2.0 and about 6.0 microns and a sensor featuring between about 0.5 and about 25 megapixels

31. The CNC cutting machine of claim 30, wherein the microscope is a long working distance microscope.

32. The CNC cutting machine of claim 31, wherein the long working distance microscope has an objective magnification of at least 2× and a numerical aperture of at least 0.05.

33. A CNC cutting machine including a cutting tool, comprising:
a machine vision camera;
a microscope; and
a light source adapted for lighting the cutting tool to allow collection of cutting tool images with the machine vision camera; and
a cutting tool cleaning device adapted for cleaning the cutting tool before the collection of cutting tool images with the machine vision camera.

34. A method of in-process monitoring of a machine cutting tool, comprising:
displacing a spindle to position the machine cutting tool held in the spindle for monitoring with a machine vision camera;
collecting at least one image of a first cutting edge of the cutting tool,
repositioning the machine cutting tool held in the spindle; and
collecting at least one image of another cutting edge of the cutting tool until all cutting edges of the cutting tool have been imaged.

35. (canceled)

36. (canceled)

37. The method of claim 34, further including repositioning the cutting tool held in the spindle for machining of a workpiece.

38. The method of claim 37, further including cleaning any workpiece chips and coolant from the cutting tool prior to collecting any of the images.

39. The method of claim 38, wherein the cleaning is performed by displacing the cutting tool held in the spindle into an air stream that blasts the workpiece chips and the coolant from the cutting tool.

40. The method of claim 39, wherein the cleaning is performed by displacing the cutting tool held in the spindle into a brush that whisks the workpiece chips and the coolant from the cutting tool.

41. The method of claim 40, wherein the cleaning is performed by displacing the cutting tool held in the spindle into a brush and an air stream to whisk and blast the workpiece chips and the coolant from the cutting tool.
